(19) United States
(12) Patent Application Publication
(10) Pub. No.: US 2026/0073789 A1
(43) Pub. Date: Mar. 12, 2026

(54) METHOD FOR PROVIDING ACCIDENT INFORMATION USING VIDEO COLLECTED FROM VEHICLE, AND AN APPARATUS IMPLEMENTING THE SAME

(71) Applicant: HYUNDAI AUTOEVER CORP., Seoul (KR)

(72) Inventors: Won Heung Jo, Seoul (KR); Hee Eun Lee, Seoul (KR); Esther Choi, Seoul (KR); Joo Ho Chae, Seoul (KR); Il Kyun Kim, Seoul (KR); Min Jeong Kim, Seoul (KR); Yeon Kyung Chung, Seoul (KR); Hwa Hyeon Hong, Seoul (KR); Rak Jun Sung, Seoul (KR)

(73) Assignee: HYUNDAI AUTOEVER CORP., Seoul (KR)

(21) Appl. No.: 19/322,253

(22) Filed: Sep. 8, 2025

(30) Foreign Application Priority Data
Sep. 12, 2024 (KR) 10-2024-0124795

(51) Int. Cl. G08G 1/01; G08G 1/017

(52) U.S. Cl. CPC G08G 1/0133; G08G 1/0141; G08G 1/0175

(57) ABSTRACT

A method for providing accident information includes determining a congestion starting point using first videos collected from vehicles driving on roads in respective regions. The method also includes identifying an accident occurrence point based on a result of analyzing second videos collected for a predetermined period from a time of passing the congestion starting point from vehicles that have passed the congestion starting point. The method additionally includes providing information on the accident occurrence point to display devices provided in vehicles located within a predetermined radius from the accident occurrence point.

### CROSS-REFERENCE TO RELATED APPLICATION

This application claims the benefit of and priority to Korean Patent Application No. 10-2024-0124795, filed on Sep. 12, 2024, the entire contents of which are hereby incorporated herein by reference.

### TECHNICAL FIELD

The present disclosure relates to a method and an apparatus for providing accident information.

### BACKGROUND

In order to provide road traffic conditions and traffic accident-related information by region across the country, video recorded in real time by closed circuit televisions (CCTVs) installed on roads is mainly used.

CCTVs are mostly installed on highways and main roads. However, CCTVs may not be installed on country roads, alleys, or certain roads with low traffic volume.

Furthermore, even on roads where CCTVs are installed, there are often cases where the CCTVs are malfunctioning or their performance is poor, making it difficult to identify objects in the recorded videos.

Since there are many situations in which CCTV videos are difficult to utilize, relying solely on CCTVs makes it challenging to obtain information on minor and major traffic accidents occurring in various regions.

### SUMMARY

Aspects of the present disclosure provide a method and an apparatus for providing accident information using video collected from a vehicle, that analyze video recorded by a vehicle's black box or camera sensor to provide accurate information on road congestion and accident occurrence, even when closed circuit televisions (CCTVs) are not installed or not available.

Aspects of the present disclosure provide a method and an apparatus for providing accident information using video collected from a vehicle, that identify the starting point of congestion on a road by detecting whether emergency lights or turn signals of a vehicle ahead are flashing in black box footage.

Aspects of the present disclosure provide a method and an apparatus for providing accident information using video collected from a vehicle, that evaluate the risk level at an accident location using black box footage and air quality measurement data, and providing accident-related information to following vehicles according to the risk level.

The objectives of the present disclosure are not limited to those mentioned above. Other objectives not explicitly stated herein should be more clearly understood by those having ordinary skill in the art based on the following description.

According to an aspect of the present disclosure, a method for providing accident information is provided. The method may be performed by a computing system. The method includes determining a congestion starting point using first videos collected from vehicles driving on roads in respective regions. The method also includes identifying an accident occurrence point based on a result of analyzing second videos collected for a predetermined period from a time of passing the congestion starting point from vehicles that have passed the congestion starting point. The method additionally includes providing information on the accident occurrence point to display devices provided in vehicles located within a predetermined radius from the accident occurrence point.

In some embodiments, the first videos may include videos recorded by black boxes provided in the vehicles driving on the roads in the respective regions or videos recorded by camera sensors mounted in the vehicles driving on the roads in the respective regions, and the second videos may include videos recorded by black boxes provided in the vehicles that have passed the congestion starting point or videos recorded by camera sensors mounted in the vehicles driving that have passed the congestion starting point.

In some embodiments, determining the congestion starting point using the first videos may include determining the congestion starting point using at least one of emergency light flashing information or turn signal flashing information detected from the first videos.

In some embodiments, determining the congestion starting point using the first video may include, for a road on which closed circuit television (CCTV) videos are available, determining the congestion starting point using both the first videos and the CCTV videos.

In some embodiments, the second videos may include videos recorded by black boxes of the vehicles that have passed the congestion starting point. Identifying the accident occurrence point based on the result of analyzing the second videos may include identifying a location of the accident occurrence point using location data of the black boxes of the vehicles that have passed the congestion starting point.

In some embodiments, identifying the accident occurrence point based on the result of analyzing the second video may include dividing each of the second videos collected from the vehicles that have passed the congestion starting point into a plurality of time segments, and storing information on first time segments among the plurality of time segments in which the accident occurrence point is identified and partial videos of the second videos corresponding to the first time segments of the second videos.

In some embodiments, providing of information on the accident occurrence point to the display devices provided in the vehicles may include transmitting the partial videos corresponding to the first time segments to the display devices.

In some embodiments, identifying the accident occurrence point based on the result of analyzing the second videos may include acquiring air quality measurement data sensed by air quality sensors provided in the vehicles that have passed the congestion starting point, and determining an accident risk level of the accident occurrence point from among a plurality of predefined accident risk levels using at least one of the second videos or the air quality measurement data.

In some embodiments, determining the accident risk level of the accident occurrence point may include determining the accident risk level of the accident occurrence point based on a number of collisions analyzed from the second videos and an occurrence of a fire identified using the air quality measurement data.

In some embodiments, providing the information on the accident occurrence point to the display devices provided in the vehicles may include, when the accident risk level of the accident occurrence point is equal to or greater than a threshold level, transmitting accident warning information to the display devices of vehicles located within a first predetermined radius from the accident occurrence point, and transmitting information on emergency response measures along with the accident warning information and a video of the accident occurrence point to the display devices of vehicles located within a second predetermined radius from the accident occurrence point. The first predetermined radius may be smaller than the second predetermined radius.

In some embodiments, the display devices provided in the vehicles may include navigation devices.

In some embodiments, the method may further comprise receiving an accident report including black box videos from black boxes of the vehicles that have passed the congestion starting point or terminals of drivers of the vehicles that have passed the congestion starting point, identifying the accident occurrence point using the black box videos, and providing a reward for a toll discount to accounts of the drivers who have submitted the accident report.

According to another aspect of the present disclosure, a method for providing accident information is provided. The method may be performed by a computing system. The method includes identifying an accident occurrence point based on a result of analyzing at least one of black box videos collected from vehicles driving on roads in respective regions and CCTV videos collected from CCTVs located along the roads. The method also includes providing information on the accident occurrence point to navigation devices provided in vehicles located within a predetermined radius from the accident occurrence point.

According to yet another aspect of the present disclosure, a computing system is provided. The system includes at least one processor, a communication interface configured to communicate with an external device, a memory configured to load computer-readable instructions executable by the at least one processor, and a storage configured to store the computer-readable instructions. The computer-readable instructions, when executed by the at least one processor, cause the at least one processor to perform operations. The operations include an operation of determine a congestion starting point using first videos collected from vehicles driving on roads in respective regions. The operations also includes an operation of identify an accident occurrence point based on a result of analyzing second videos collected for a predetermined period from a time of passing the congestion starting point from vehicles that have passed the congestion starting point. The operations additionally include an operation of provide information on the accident occurrence point to display devices provided in vehicles located within a predetermined radius from the accident occurrence point.

In some embodiments, the operation of determining the congestion starting point using the first videos may include determining the congestion starting point using at least one of emergency light flashing information or turn signal flashing information detected from the first videos.

In some embodiments, the operation of identifying the accident occurrence point based on the result of analyzing the second videos may include acquiring air quality measurement data sensed by air quality sensors provided in the vehicles that have passed the congestion starting point, and determining an accident risk level of the accident occurrence point from among a plurality of predefined accident risk levels, using at least one of the second videos or the air quality measurement data.

In some embodiments, the operation of determining the accident risk level of the accident occurrence point may include determining the accident risk level of the accident occurrence point based on a number of collisions analyzed from the second videos and an occurrence of a fire identified using the air quality measurement data.

In some embodiments, the operation of providing the information on the accident occurrence point to the display devices provided in the vehicles may include, when the determined accident risk level of the accident occurrence point is equal to or greater than a threshold level, transmitting accident warning information to the display devices of vehicles located within a first predetermined radius from the accident occurrence point, and transmitting information on emergency response measures along with the accident warning information and a video of the accident occurrence point to the display devices of vehicles located within a second predetermined radius from the accident occurrence point, wherein the first predetermined radius may be smaller than the second predetermined radius.

In some embodiments, the operation of identifying the accident occurrence point based on the result of analyzing the second videos may include dividing each of the second videos collected from the vehicles that have passed the congestion starting point into a plurality of time segments, and storing information on first time segments among the plurality of time segments in which the accident occurrence point is identified and partial videos of the second videos corresponding to the first time segments.

In some embodiments, the operation of providing the information on the accident occurrence point to the display devices provided in the vehicles may include transmitting the partial videos corresponding to the first time segments to the display devices.

Aspects of the present disclosure provide a method and an apparatus that enable obtaining information in real time regarding accident locations and details in situations such as vehicle collisions, multiple-vehicle crashes, and vehicle fires occurring on roads, even in environments where CCTVs are not available or are difficult to use.

Aspects of the present disclosure provide a method and an apparatus that, when a traffic accident has occurred on a road, provide, to other vehicles driving on the road towards the accident location, real-time information on the severity of the accident and whether it is possible to take a detour via another road.

According to aspects of the present disclosure, when there is severe congestion on a road, drivers of vehicles traveling on the same road are able to quickly obtain information on whether there is a risk of an accident ahead.

The effects of the present disclosure are not limited to those described above. Other effects of the present disclosure not mentioned herein should be more apparent to those having ordinary skill in the art from the following description.

### BRIEF DESCRIPTION OF THE DRAWINGS

The above and other aspects and features of the present disclosure should become more apparent from the following detailed description taken in conjunction with the accompanying drawings, in which:

FIG. 1 is a diagram of a system for providing a service of an accident information provision system according to an embodiment of the present disclosure;

FIG. 2 is a flowchart of a method for providing accident information using video collected from a vehicle according to an embodiment of the present disclosure;

FIGS. 3-5 are detailed flowcharts for explaining various steps or operations illustrated in FIG. 2;

FIG. 6 is a flowchart of a method for providing accident information using video collected from a vehicle according to another embodiment of the present disclosure;

FIG. 7 is a diagram illustrating an example of how to identify a congestion starting point and an accident occurrence point according to some embodiments of the present disclosure;

FIG. 8 is a diagram illustrating an example of how to provide accident video of the accident occurrence point to the navigation devices of following vehicles according to some embodiments of the present disclosure;

FIG. 9 is a diagram illustrating examples of videos and data used in determining the congestion starting point and accident occurrence point according to some embodiments of the present disclosure;

FIG. 10 is a diagram illustrating an example of accident risk level classification at the accident occurrence point and corresponding measures for nearby vehicles according to some embodiments of the present disclosure;

FIG. 11 is a diagram illustrating an example of how to provide a toll discount service according to accident report reception according to some embodiments of the present disclosure; and

FIG. 12 is a block diagram illustrating the hardware configuration of a computing system that may be configured to implement methods according to some embodiments of the present disclosure.

### DETAILED DESCRIPTION

Hereinafter, embodiments of the present disclosure are described in detail with reference to the accompanying drawings. The advantages and features of the present disclosure and methods of accomplishing the same may be understood more clearly may those of ordinary skill in the art from the following detailed description of embodiments and the accompanying drawings. The present disclosure may, however, be embodied in many different forms and should not be construed as being limited to the embodiments set forth herein. Rather, these embodiments are provided to make this disclosure thorough and complete and to fully convey the concept of the disclosure to those having ordinary skill in the art. The present disclosure is defined only by the appended claims and equivalents thereof.

In assigning reference numerals to the components of the drawings, it should be noted that the same reference numerals are assigned to the same components as much as possible even when the components are shown in different drawings. In addition, in the present disclosure, where it was determined that a detailed description of the related well-known configuration or function may obscure the gist of the present disclosure, the detailed description thereof has been omitted.

Unless otherwise defined, all terms used in the present specification, including technical and scientific terms, should be construed to have meanings commonly understood by those having ordinary skill in the art. In addition, the terms defined in the commonly used dictionaries should not be ideally or excessively interpreted unless the terms are specifically defined otherwise herein or apparent from the context. The terminology used herein is for the purpose of describing embodiments and is not intended to be limiting of the present disclosure. In this specification, the singular also includes the plural unless specifically stated otherwise.

In addition, in describing components of the present disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between the components.

The terms “comprise”, “comprising: “include”, “including”, “have”, “having”, etc. when used in this specification, specify the presence of stated features, integers, steps, operations, elements, components, and/or combinations of them but do not preclude the presence or addition of one or more other features, integers, steps, operations, elements, components, and/or combinations thereof.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings.

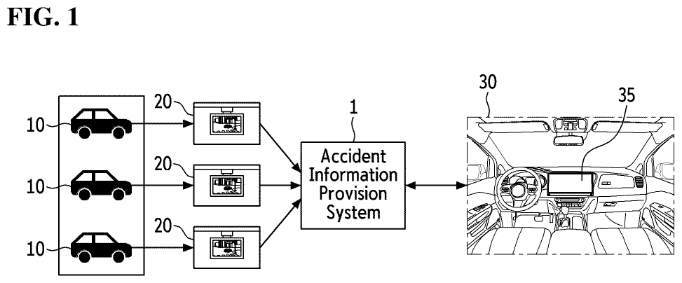

FIG. 1 is a configuration diagram for providing a service of an accident information provision system according to an embodiment of the present disclosure.

Referring to FIG. 1, an accident information provision system 1 according to an embodiment of the present disclosure is connected via a network to black box devices 20 mounted inside vehicles 10 and to navigation devices 35 mounted inside vehicles 30, which are service targets.

The vehicles 10, which are vehicles driving on roads in respective regions, provide, to the accident information provision system 1, videos recorded by the black box devices 20 or videos recorded by camera sensors mounted outside the vehicles 10.

The vehicles 30 are vehicles located within a predetermined radius from an accident occurrence point and receive information on the accident occurrence point from the accident information provision system 1.

In an embodiment, the vehicles 30 may correspond to the vehicles 10.

The accident information provision system 1 may collect in real time black box videos or camera-recorded videos received from the vehicles 10 driving on roads in respective regions, and may analyze the videos collected in real time to identify a congestion starting point. In this case, for video analysis, an object recognition algorithm corresponding to, for example, computer vision technology may be used.

Once the congestion starting point is identified, the accident information provision system 1 may analyze black box videos or camera-recorded videos collected for a predetermined period from the time of passing the congestion starting point from the vehicles 10 that have passed the congestion starting point, to identify an accident occurrence point. In identifying the accident occurrence point, if air quality measurements are available from air quality sensors mounted in the vehicles 10, the accident occurrence point may be identified through the analysis of both the collected videos and the air quality measurements.

Once the accident occurrence point is identified, the accident information provision system 1 may provide accident information on the accident occurrence point to the navigation devices 35 of the vehicles 30 located within a predetermined radius from the accident occurrence point (e.g., vehicles located within a 1 km radius behind, or traveling towards, the accident occurrence point).

The accident information provided to the navigation devices 35 of the vehicles 30 may include, for example, a real-time video or still image of the accident occurrence point, text information on the type of accident (e.g., minor collision, two-vehicle collision, three-vehicle collision, vehicle rollover, large-scale fire, etc.), accident-related news information, and/or detour information.

According an embodiment, the accident information provision system 1 may provide accurate information on road congestion and accident occurrence by analyzing videos recorded by black boxes or camera sensors provided in vehicles, even when closed circuit televisions (CCTVs) are not installed or are not available.

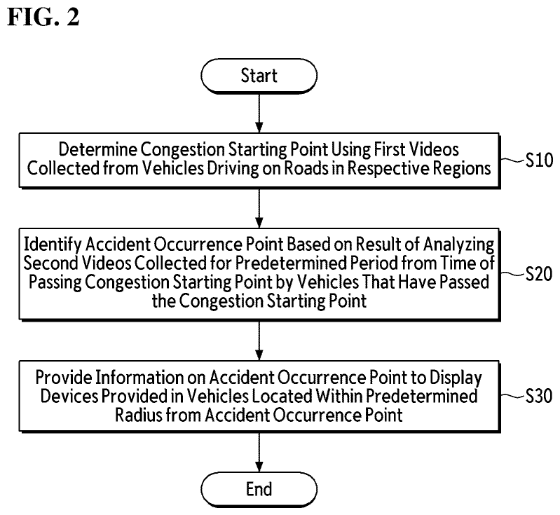

FIG. 2 is a flowchart of a method for providing accident information using video collected from a vehicle according to an embodiment of the present disclosure.

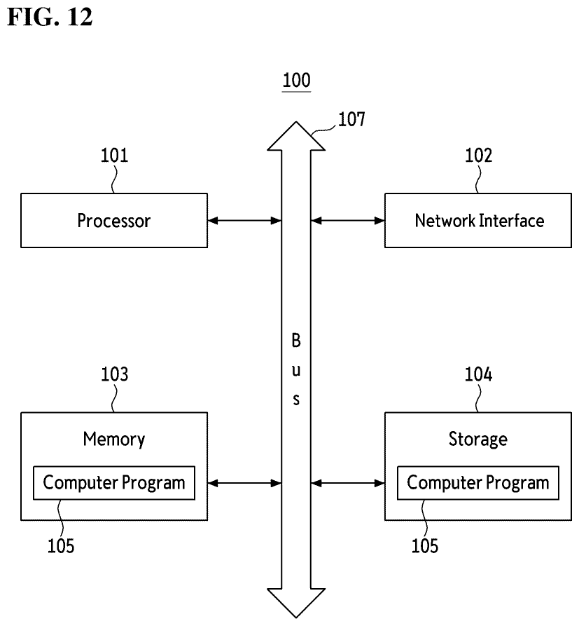

The method for providing accident information using video collected from a vehicle according to an embodiment of the present disclosure may be performed by the accident information provision system 1 illustrated in FIG. 1. The accident information provision system 1 that executes the method for providing accident information using video collected from a vehicle according to an embodiment of the present disclosure may comprise a computing system 100 illustrated in FIG. 12. The accident information provision system 1 may be, for example, a server that provides traffic information or a server that provides a navigation service.

In the method for providing accident information using video collected from a vehicle according to an embodiment of the present disclosure, descriptions of the entity that performs certain operations or steps may be omitted, in which case, it should be understood that the entity is the computing system 100.

According to the embodiment to be described below, an accident occurrence point may be accurately identified by collecting and analyzing in real time video recorded by black boxes or camera sensors of vehicles driving on roads in respective regions, and accident-related information on the identified accident occurrence point can be provided in real time.

Referring to FIG. 2, in a step or operation S10, the computing system 100 determines a congestion starting point using first videos collected from vehicles driving on roads in respective regions. In an embodiment, the first videos may be, for example, videos recorded by black boxes in the vehicles or videos recorded by camera sensors mounted in the vehicles.

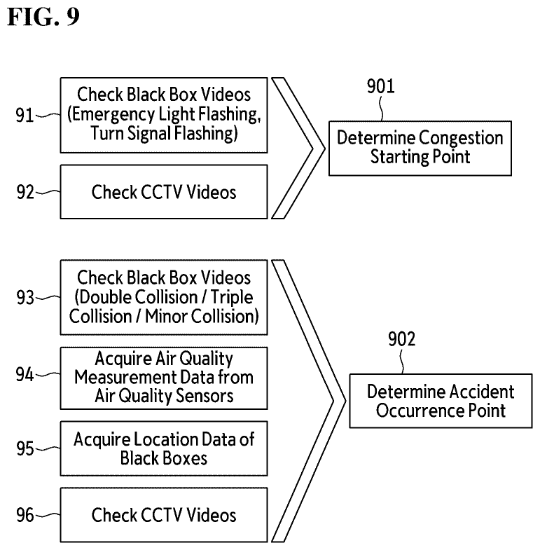

In an embodiment, referring to FIG. 9, the computing system 100 may determine a congestion starting point 901 using emergency light flashing information and turn signal flashing information of vehicles recognized in real-time collected black box videos 91 and closed circuit television (CCTV) videos 92. The emergency light flashing information may refer to detailed measurements of emergency light operation in road congestion or emergency situations. The emergency light flashing information may include, for example, the number of flashes or flashing duration of each emergency light. The turn signal flashing information may refer to detailed measurements of left/right turn signal operation in road congestion or emergency situations. The turn signal flashing information may include, for example, the number of flashes or flashing duration of each left/right turn signal.

In this case, the computing system 100 may determine the congestion starting point 901 by analyzing only the black box videos 91 regardless of the presence of the CCTV videos 92.

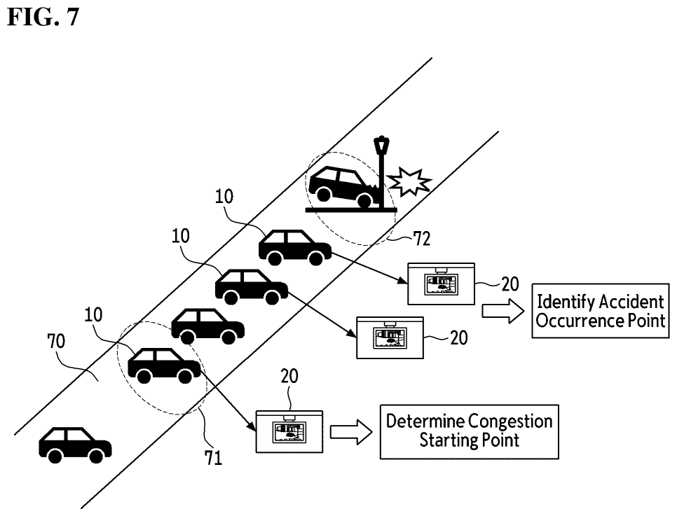

For example, referring to FIG. 7, the computing system 100 may collect in real time the black box videos recorded by black box devices 20 of vehicles 10 driving on a road 70 and, if the number of flashes of the emergency lights of a front vehicle 10 recognized in each collected black box video satisfies a threshold condition (e.g., exceeds a threshold), or if the turn signal of the front vehicle 10 operates in either the left or right direction for a certain period (e.g., for more than a threshold period), the computing system 100 may determine a congestion starting point 71 based on the positions of the vehicles 10 that have provided the corresponding video.

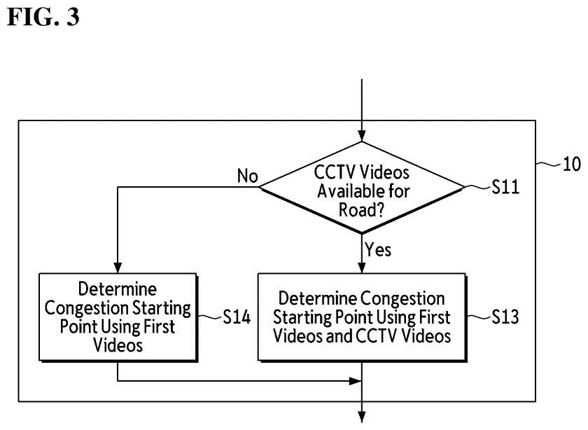

In an embodiment, referring to FIG. 3, in a step or operation S11, the computing system 100 determines the presence of CCTV videos. If CCTV videos are present (“Yes in the step or operation S11”), the computing system 100 may determine the congestion starting point in a step or operation S14 using both the first videos and the CCTV videos. If no CCTV videos are present (“No in the step or operation S11”), the computing system 100 may determine the congestion starting point in a step or operation S13 using the first videos alone.

In a step or operation S20, the computing system 100 identifies an accident occurrence point based on the result of analyzing second videos collected for a preset period from the vehicles after passing the congestion starting point. The second videos may be, for example, videos recorded by the black boxes provided in the vehicles or videos recorded by the camera sensors mounted in the vehicles. Additionally, the computing system 100 may identify the precise location of the accident occurrence point using location data of the black boxes.

In an embodiment, referring to FIG. 9, the computing system 100 may determine an accident occurrence point 902 using information on whether a two-vehicle collision, three-vehicle collision, or minor collision has been identified from real-time collected black box videos 93, air quality measurement data sensed by air quality sensors 94, black box location data 95, and CCTV videos 96. In this case, the computing system 100 may also determine the accident occurrence point 902 using only the black box videos 93 and the black box location data 95.

In the example of FIG. 7, the computing system 100 may identify the location of an accident occurrence point 72 by analyzing black box videos collected from black box devices 20 of vehicles 10 that have passed the congestion starting point 71 on the road 70. The computing system 100 may also identify the type of accident that has occurred at the accident occurrence point 72 (such as minor collision, two-vehicle collision, three-vehicle or more collision, vehicle rollover, sinkhole, etc.) and whether a fire has occurred. In an embodiment, the occurrence of a fire at the accident occurrence point 72 may be identified not only using black box videos, but also by referring to air quality measurement data obtained using air quality sensors mounted in the vehicles 10 or on the road 70, if available.

In a section where CCTVs are present, both black box videos and CCTV videos may be analyzed to identify the location and situation of the accident occurrence point 72.

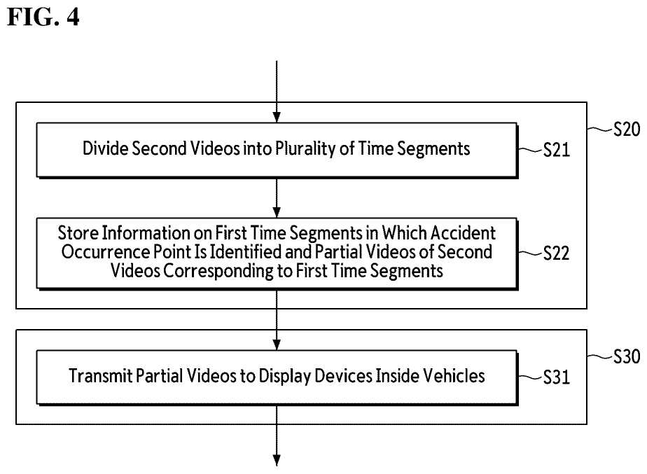

In an embodiment, referring to FIG. 4, in a step or operation S21, the computing system 100 divides each of the second videos into a plurality of time segments. In a step or operation S22, the computing system 100 stores information on a first time segment among the plurality of time segments where the accident occurrence point has been identified, and partial videos of the second videos corresponding to the first time segments. The stored partial videos may be videos showing the scene of the accident occurrence point.

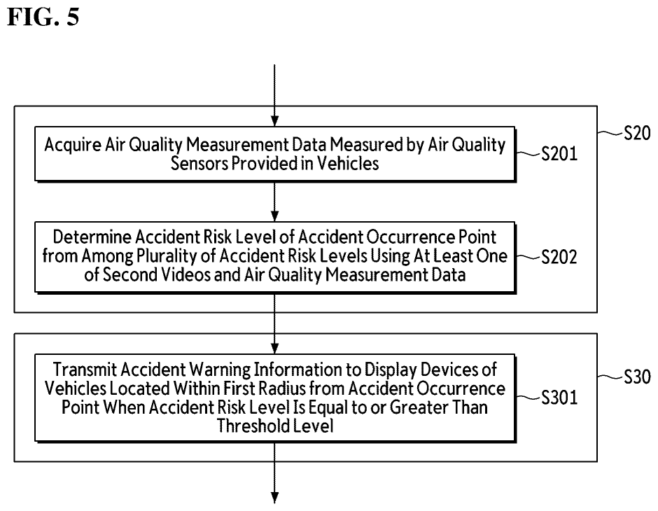

In an embodiment, referring to FIG. 5, in a step or operation S201, the computing system 100 may acquire air quality measurement data sensed by an air quality sensor from each vehicle equipped with the air quality sensor.

In a step or operation S202, the computing system 100 may determine the accident risk level at the accident occurrence point from among a plurality of preset accident risk levels, using at least one of the second videos and the air quality measurement data acquired in the step or operation S201.

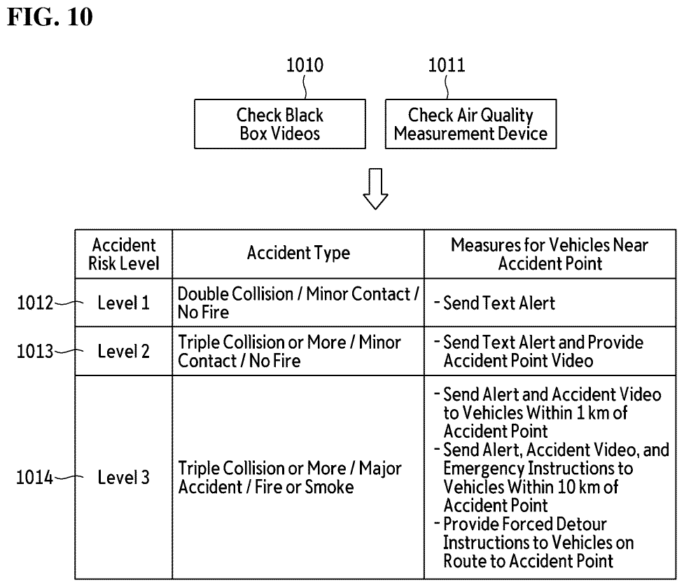

For example, as illustrated in FIG. 10, the computing system 100 may determine an accident risk level at the accident occurrence point as, for example, Level 1, Level 2, or Level 3, based on information such as the number of collisions (e.g., two-vehicle, three-vehicle, or multi-vehicle collisions) analyzed from black box videos 1010, whether a minor collision has occurred, whether a major accident (e.g., rollover or sinkhole) has occurred, and whether fire or smoke has been identified using air quality measurement data 1011.

Referring again to FIG. 2, finally, in a step or operation S30, the computing system 100 provides accident information on the identified accident occurrence point to display devices in vehicles located within a predetermined radius from the accident occurrence point.

In an embodiment, the display devices provided in the vehicles may correspond to the navigation devices 35 mounted in the vehicles 30 illustrated in FIG. 1. In addition to the navigation devices 35, the display devices may also include smartphones, smartwatches, tablets, or the like used by passengers in the vehicles 30, or TVs or similar devices mounted in the vehicles 30.

Additionally, in providing accident information on the accident occurrence point, the computing system 100 may also provide only voice information through audio devices provided in the vehicles, in addition to the display devices.

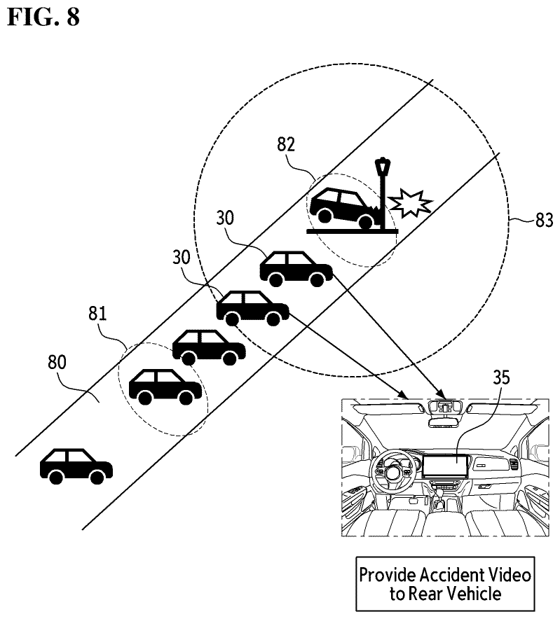

For example, referring to FIG. 8, when a congestion starting point 81 and an accident occurrence point 82 are identified on a road 80, the computing system 100 may acquire real-time videos, still images, or audio information of the accident occurrence point 82 using black box videos collected from vehicles 30 that have passed the congestion starting point 81 and are near the accident occurrence point 82.

In this case, the computing system 100 may provide the acquired videos and audio information of the accident occurrence point 82, as described above, to the navigation devices 35 of vehicles 30 located within a predetermined radius 83 from the accident occurrence point 82, or to the navigation devices 35 of rear vehicles 30 located between the congestion starting point 81 and the accident occurrence point 82.

In an embodiment, referring to FIG. 4, in a step or operation S31, the computing system 100 may transmit, to display devices inside the vehicles, partial videos of the second videos corresponding to the first time segments of the second videos where the accident occurrence point has been identified, stored in the step or operation S22.

In an embodiment, referring to FIG. 5, in a step or operation S301, when the accident risk level of the accident occurrence point determined in the step or operation S202 is equal to or higher than a threshold level, the computing system 100 may transmit accident warning information to the display device of each vehicle located within a predetermined first radius from the accident occurrence point.

For example, referring to the table in FIG. 10, the computing system 100 may take slightly different measures via the navigation devices 35 of nearby vehicles 30, depending on the accident risk level (1012, 1013, or 1014) of the accident occurrence point as determined using the black box videos 1010 and the air quality measurement data 1011.

For example, when the accident risk level is the lowest, “Level 1” 1012, a text alert on the accident details may be sent to the navigation devices 35 of vehicles 30 located within a 10 km radius from the accident occurrence point.

Additionally, when the accident risk level is “Level 2” 1013, which is higher than “Level 1” 1012, the navigation devices 35 of vehicles 30 located within a 10 km radius from the accident occurrence point may be provided with both the text alert on the accident details and a video of the accident occurrence point.

Additionally, when the accident risk level is the highest, “Level 3” 1014, the video of the accident occurrence point may be transmitted along with warning information to the navigation devices 35 of vehicles 30 located within a 1 km radius from the accident occurrence point, and the navigation devices 35 of vehicles 30 located within a 10 km radius may be provided with warning information, the video of the accident occurrence point, and information on emergency response measures. Furthermore, guidance on a forced detour route may be provided via the navigation devices 35 of vehicles 30 at a junction before reaching the accident occurrence point.

According to embodiments of the present disclosure, when CCTVs are not installed or CCTV videos are difficult to utilize, it becomes possible to accurately identify an accident occurrence point using black box videos from vehicles and to quickly analyze the cause of the accident for response.

Additionally, by evaluating the risk level of the accident occurrence point and quickly guiding rear vehicles with accident-related information according to the risk level, safe driving can be promoted and the occurrence of additional accidents can be prevented in advance.

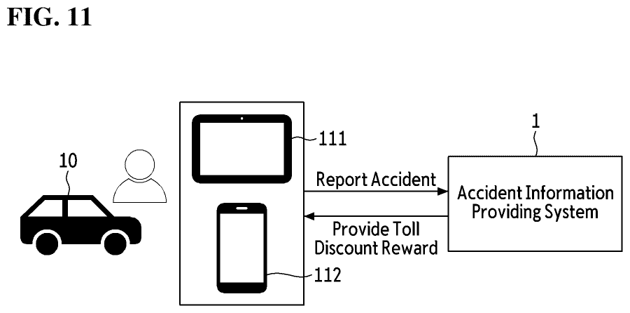

In an embodiment, referring to FIG. 11, the accident information provision system 1 may receive an accident report including a black box video from a black box 111 of a vehicle 10 or a driver's terminal 112 (such as a smartphone, tablet, smartwatch, etc.) and may identify the accident occurrence point using the received black box video.

In an embodiment, the accident information provision system 1 may provide a reward for toll discount to the account of the driver who has submitted the accident report, and as a result, the toll may be automatically discounted when the vehicle 10 passes through a tollgate.

In an embodiment, when an accident is detected in the black box video from the vehicle 10, the black box device 20 may display a GUI (not illustrated) for receiving input to provide the black box video and obtain the reward.

For example, when an accident is detected in the black box video, the black box device 20 may display a pop-up message such as “Would you like to share the black box video of the current accident area to receive a toll discount?” and if the driver selects a “Yes” button in response, the black box video from the vehicle 10 may be automatically provided to the computing system 100.

Accordingly, in order to obtain accident information on a road where CCTVs are not available, it is possible to provide a motivation for the driver of the vehicle 10 to actively share the black box video.

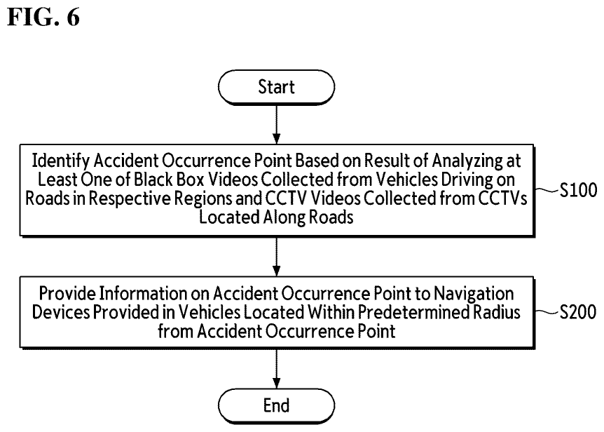

FIG. 6 is a flowchart of a method for providing accident information using video collected from a vehicle according to another embodiment of the present disclosure.

The method for providing accident information using video collected from a vehicle according to another embodiment of the present disclosure may be executed by the accident information provision system 1 illustrated in FIG. 1. The accident information provision system 1 that executes the method for providing accident information using video collected from a vehicle according to another embodiment of the present disclosure may comprise the computing system 100 illustrated in FIG. 12. The accident information provision system 1 may be, for example, a server that provides traffic information or a server that provides a navigation service.

In the method for providing accident information using video collected from a vehicle according to another embodiment of the present disclosure, descriptions of the entity that performs certain operations or steps may be omitted, in which case, it is to be understood that the entity is the computing system 100.

Referring to FIG. 6, in a step or operation S100, the computing system 100 identifies an accident occurrence point based on the result of analyzing at least one of black box videos collected from vehicles driving on roads in respective regions and CCTV videos collected from CCTVs installed along the roads.

In a step or operation S200, the computing system 100 provides information on the accident occurrence point to navigation devices provided in vehicles located within a predetermined radius from the accident occurrence point.

In an embodiment, in the case of roads equipped with CCTVs, the computing system 100 may analyze both the black box videos from the vehicles and the CCTV videos to accurately identify the accident occurrence point and quickly provide information related to the accident to nearby vehicles.

According to embodiments of the present disclosure, accurate information on road congestion and accident occurrence can be provided by analyzing black box videos from vehicles.

Additionally, by using black box videos from vehicles to quickly provide information on the risk level of the accident occurrence point and accident-related video to rear vehicles, it is possible to promote safe driving and prevent the occurrence of additional accidents in advance.

FIG. 12 is a hardware configuration diagram of the computing system 100, according to an embodiment.

Referring to FIG. 12, the computing system 100 may include one or more processors 101, a bus 107, a network interface 102, a memory 103, which loads a computer program 105 executed by the processors 101, and a storage 104 for storing the computer program 105.

The processor 101 controls overall operations of each component of computing system 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing system 100 may have one or more processors.

The memory 103 stores various data, instructions and/or information. The memory 103 may load one or more programs 105 (e.g., in the form of computer-readable instructions) from the storage 104 to execute methods/operations according to various embodiments of the present disclosure. An example of the memory 103 may be a RAM, but is not limited thereto.

The bus 107 provides communication between components of computing system 100. The bus 107 may be implemented as various types of bus such as an address bus, a data bus and a control bus.

The network interface 102 supports wired and wireless internet communication of the computing system 100. The network interface 102 may support various communication methods other than internet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 105 may include one or more computer-readable instructions, on which the methods/operations according to various embodiments of the present disclosure are implemented. When the computer program 105 is loaded on the memory 103, the processor 101 may perform the methods/operations in accordance with various embodiments of the present disclosure by executing the one or more instructions.

In an embodiment, a computer program 105 may include instructions for performing the operations of: identifying an accident occurrence point based on the result of analyzing at least one of black box videos collected from vehicles driving on roads in respective regions and CCTV videos collected from CCTVs installed along the roads; and providing information on the accident occurrence point to navigation devices provided in vehicles located within a predetermined radius from the accident occurrence point.

In another embodiment, the computer program 105 may include instructions for performing the operations of: determining a congestion starting point using first videos collected from a plurality of vehicles driving on roads in respective regions; identifying an accident occurrence point based on the result of analyzing second videos collected for a predetermined period from the time of passing the congestion starting point from vehicles that have passed the congestion starting point; and providing information on the accident occurrence point to display devices provided in vehicles located within a predetermined radius from the accident occurrence point.

The technical features of the present disclosure may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those having ordinary skill in the art should appreciate that many variations and modifications can be made to the preferred embodiments without substantially departing from the principles of the present disclosure. Therefore, the described embodiments of the present disclosure are provided in a generic and descriptive sense only and not for purposes of limitation.

What is claimed is:

1. A method, performed by a computing system, for providing accident information, the method comprising:
determining a congestion starting point using first videos collected from vehicles driving on roads in respective regions;
identifying an accident occurrence point based on a result of analyzing second videos collected for a predetermined period from a time of passing the congestion starting point from vehicles that have passed the congestion starting point; and
providing information on the accident occurrence point to display devices provided in vehicles located within a predetermined radius from the accident occurrence point.

2. The method of claim 1, wherein:
the first videos include videos recorded by black boxes provided in the vehicles driving on the roads in the respective regions or videos recorded by camera sensors mounted in the vehicles driving on the roads in the respective regions; and
the second videos include videos recorded by black boxes provided in the vehicles that have passed the congestion starting point or videos recorded by camera sensors mounted in the vehicles driving that have passed the congestion starting point.

3. The method of claim 1, wherein determining the congestion starting point using the first videos includes determining the congestion starting point using at least one of emergency light flashing information or turn signal flashing information detected from the first videos.

4. The method of claim 1, wherein determining the congestion starting point using the first video includes, for a road on which closed circuit television (CCTV) videos are available, determining the congestion starting point using both the first videos and the CCTV videos.

5. The method of claim 1, wherein:
the second videos include videos recorded by black boxes of the vehicles that have passed the congestion starting point; and
identifying the accident occurrence point based on the result of analyzing the second videos includes identifying a location of the accident occurrence point using location data of the black boxes of the vehicles that have passed the congestion starting point.

6. The method of claim 1, wherein identifying the accident occurrence point based on the result of analyzing the second video includes:
dividing each of the second videos collected from the vehicles that have passed the congestion starting point into a plurality of time segments; and
storing information on first time segments among the plurality of time segments in which the accident occurrence point is identified and partial videos of the second videos corresponding to the first time segments of the second videos.

7. The method of claim 6, wherein providing the information on the accident occurrence point to the display devices provided in the vehicles includes transmitting the partial videos corresponding to the first time segments to the display devices.

8. The method of claim 1, wherein identifying the accident occurrence point based on the result of analyzing the second videos includes:
acquiring air quality measurement data sensed by air quality sensors provided in the vehicles that have passed the congestion starting point; and
determining an accident risk level of the accident occurrence point from among a plurality of predefined accident risk levels, using at least one of the second videos or the air quality measurement data.

9. The method of claim 8, wherein determining the accident risk level of the accident occurrence point includes determining the accident risk level of the accident occurrence point based on a number of collisions analyzed from the second videos and an occurrence of a fire identified using the air quality measurement data.

10. The method of claim 8, wherein providing the information on the accident occurrence point to the display devices provided in the vehicles includes:
when the accident risk level of the accident occurrence point is equal to or greater than a threshold level,
transmitting accident warning information to the display devices of vehicles located within a first predetermined radius from the accident occurrence point, and
transmitting information on emergency response measures along with the accident warning information and a video of the accident occurrence point to the display devices of vehicles located within a second predetermined radius from the accident occurrence point, wherein
the first predetermined radius is smaller than the second predetermined radius.

11. The method of claim 1, wherein the display devices provided in the vehicles are navigation devices.

12. The method of claim 1, further comprising:
receiving an accident report including black box videos from black boxes of the vehicles that have passed the congestion starting point or terminals of drivers of the vehicles that have passed the congestion starting point;
identifying the accident occurrence point using the black box videos; and
providing a reward for a toll discount to accounts of the drivers who have submitted the accident report.

13. A method, performed by a computing system, for providing accident information, the method comprising:
identifying an accident occurrence point based on a result of analyzing at least one of black box videos collected from vehicles driving on roads in respective regions or closed circuit television (CCTV) videos collected from CCTVs located along the roads; and
providing information on the accident occurrence point to navigation devices provided in vehicles located within a predetermined radius from the accident occurrence point.

14. A computing system comprising:
at least one processor;
a communication interface configured to communicate with an external device;
a memory configured to load computer-readable instructions executable by the at least one processor; and
a storage configured to store the computer-readable instructions,
wherein the computer-readable instructions, when executed by the at least one processor, cause the at least one processor to perform operations, the operations including:
an operation of determining a congestion starting point using first videos collected from vehicles driving on roads in respective regions,
an operation of identifying an accident occurrence point based on a result of analyzing second videos collected for a predetermined period from a time of passing the congestion starting point from vehicles that have passed the congestion starting point, and
an operation of providing information on the accident occurrence point to display devices provided in vehicles located within a predetermined radius from the accident occurrence point.

15. The computing system of claim 14, wherein the operation of determining the congestion starting point using the first videos includes determining the congestion starting point using at least one of emergency light flashing information or turn signal flashing information detected from the first videos.

16. The computing system of claim 14, wherein the operation of identifying the accident occurrence point based on the result of analyzing the second videos includes:
acquiring air quality measurement data sensed by air quality sensors provided in the vehicles that have passed the congestion starting point; and
determining an accident risk level of the accident occurrence point from among a plurality of predefined accident risk levels, using at least one of the second videos or the air quality measurement data.

17. The computing system of claim 16, wherein the operation of determining the accident risk level of the accident occurrence point includes determining the accident risk level of the accident occurrence point based on a number of collisions analyzed from the second videos and an occurrence of a fire identified using the air quality measurement data.

18. The computing system of claim 16, wherein the operation of providing the information on the accident occurrence point to the display devices provided in the vehicles includes:
when the determined accident risk level of the accident occurrence point is equal to or greater than a threshold level,
transmitting accident warning information to the display devices of vehicles located within a first predetermined radius from the accident occurrence point, and
transmitting information on emergency response measures along with the accident warning information and a video of the accident occurrence point to the display devices of vehicles located within a second predetermined radius from the accident occurrence point,
wherein the first predetermined radius is smaller than the second predetermined radius.

19. The computing system of claim 14, wherein the operation of identifying the accident occurrence point based on the result of analyzing the second videos includes:
dividing each of the second videos collected from the vehicles that have passed the congestion starting point into a plurality of time segments; and
storing information on first time segments among the plurality of time segments in which the accident occurrence point is identified and partial videos of the second videos corresponding to the first time segments.

20. The computing system of claim 19, wherein the operation of providing the information on the accident occurrence point to the display devices provided in the vehicles includes transmitting the partial videos corresponding to the first time segments to the display devices.
